(19) United States
(12) Patent Application Publication
(10) Pub. No.: US 2018/0312446 A1
(43) Pub. Date: Nov. 1, 2018

(54) COMPOSITION AND METHODS FOR WOOD CONCRETE BOARD

(71) Applicant: VALSPAR SOURCING, INC., Minneapolis, MN (US)

(72) Inventors: Gregory B Hayes, MINNEAPOLIS, MN (US); John Mittelsteadt, MINNEAPOLIS, MN (US); Chang Chyung-Mei, MINNEAPOLIS, MN (US); MICHELLE D LIEU, MINNEAPOLIS, MN (US)

(73) Assignee: SWIMC LLC, CLEVELAND, OH (US)

(21) Appl. No.: 15/770,861

(22) PCT Filed: Oct. 25, 2016
(86) PCT No.: PCT/US16/58676

§ 371 Date: Apr. 25, 2018

Related U.S. Application Data
(60) Provisional application No. 62/248,394, filed on Oct. 30, 2015.

(51) Int. Cl. C04B 41/48; C04B 41/00; C04B 41/63; B05D 3/00; B05D 3/10

(52) U.S. Cl. CPC C04B 41/483; C04B 41/009; B05D 3/101; B05D 3/002; C04B 41/63

(57) ABSTRACT

A wood fiber composite with improved adhesion is made using the method described herein. The uncoated substrate is coated with a pretreatment, followed by coating of a sealer and a topcoat over the pretreatment. Preheating the substrate prior to pretreatment appears to increase adhesion.

### CROSS REFERENCE TO RELATED APPLICATION(S)

This application is a continuation of International Application No. PCT/US2016/058676, filed on Oct. 25, 2016, which claims priority to U.S. Provisional Application No. 62/248,394, filed 30 Oct. 2015 and entitled “Composition and Methods for Wood Concrete Board,” which is incorporated herein by reference in its entirety.

### BACKGROUND OF THE INVENTION

Wood fiber cement composites are widely used in the building industry, typically in the form of boards or compressed panels. These materials are made from wood pulp or synthetic fiber mixed with a binder that includes hydraulic cement, silica and water. The mixture is pressed, cast, molded, roll-formed, extruded or otherwise formed into a green board or panel form and dried. The dried composite boards or panels show significant advantages over traditional building materials such as vinyl, aluminum or wood siding.

Conventionally, wood fiber cement composite boards or panels are prefinished during manufacture and have a primer or paint applied thereon. But some paints show poor adhesion, particularly when the wood fiber cement composite board or panel has a smooth surface. Poorly adhered paints or coatings tend to delaminate and this is especially true for boards or panels used in extreme outdoor weather. Many coatings cannot withstand the water exposure and/or severe changes in temperature and will delaminate or prematurely fail.

From the foregoing, it will be appreciated that what is needed in the art is an exterior siding material that is a wood fiber cement composite product with improved coating adhesion and a reduced tendency to fail prematurely. Such composite products and methods for making the same are disclosed herein.

### SUMMARY

The present description provides methods and coated articles with enhanced adhesion.

In one embodiment, the methods described herein include steps of providing a non-metallic substrate and optionally preheating the substrate to a temperature of about 85° F. to 130° F. This is followed by steps of applying a pretreatment to the surface of the substrate, followed by application of a sealer and a topcoat.

In another embodiment, the present description provides a coated article. The coated article is made by a method that includes steps of providing a non-metallic substrate and optionally preheating the substrate to a temperature of about 85° F. to 130° F. This is followed by steps of applying a pretreatment to the surface of the substrate, followed by application of a sealer and a topcoat.

The above summary of the present invention is not intended to describe each disclosed embodiment or every implementation of the present invention. The description that follows more particularly exemplifies illustrative embodiments. In several places throughout the application, guidance is provided through lists of examples, which can be used in various combinations. In each instance, the recited list serves only as a representative group and should not be interpreted as an exclusive list.

The details of one or more embodiments of the invention are set for in the accompanying drawings and the description below. Other features, objects, and advantages of the invention will be apparent from the description and drawings, and from the claims.

### Selected Definitions

Unless otherwise specified, the following terms as used herein have the meanings as provided below.

The term “component” refers to any compound that includes a particular feature or structure. Examples of components include compounds, monomers, oligomers, polymers, and organic groups contained there.

The term “board,” as used herein refers to a generally planar component suitable for attachment to a building exterior surface, including lap siding, vertical siding, soffit panels, trim, shingle replica, stone replica, stucco replica, and the like. As used herein, the term may refer to pressed panels of a wood fiber composite substrate.

As used herein, the term “pretreatment” or “presealer” refers to a composition applied directly to the bare or uncoated surface of a wood fiber composite substrate. The term also refers to the process of applying the composition to the substrate. In some instances, a pretreatment may also act as a sealer.

The term “sealer” refers to a composition applied to the surface of a wood fiber composite substrate. The sealer may be applied directly to the uncoated surface or over a pretreatment applied to the substrate. Once the sealer composition is dried and/or hardened, it provides a coated surface with reduced porosity. In some instances, a sealer composition may be used as a pretreatment.

The term “primer” refers to a composition applied to the surface of a wood fiber composite substrate. The primer may be applied directly to the uncoated surface, over a pretreatment, and/or over a sealer applied to the substrate. Once the primer composition is dried or hardened, it provides a coated surface with improved ability to retain a later-applied topcoat or other decorative finish. The primer may also act as a barrier material. In some instances, a primer may be used in place of a sealer and vice-versa.

The term “topcoat” refers to a composition which when dried or hardened provides a decorative or protective outermost finish to a wood fiber composite substrate which may be attached to a building exterior. Topcoats may include paints, stains, or sealers that can withstand extended outdoor exposure without any visually observable deterioration, but paints, sealers or stains that would not withstand extended outdoor exposure are excluded from the term.

The term “smooth” as used herein, refers to a substrate with a surface that is substantially free of projections or unevenness, and has not been deliberately textured or roughened. However, a smooth surface as used herein does not indicate a surface that would produce Rz or Ra values of zero if surface roughness was measured by a profilometer.

The term “water-dispersible” in the context of a water-dispersible polymer means that the polymer can be mixed into water (or an aqueous carrier) to form a stable mixture. For example, a mixture that readily separates into immiscible layers is not a stable mixture. The term “water-dispersible” is intended to include the term “water-soluble.” In other words, by definition, a water-soluble polymer is also considered to be a water-dispersible polymer.

The term “dispersion” in the context of a dispersible polymer refers to the mixture of a dispersible polymer and a carrier. The term “dispersion” is intended to include the term “solution.”

The term “latex” when used with respect to a polymer means a dispersion or emulsion of polymer particles in water containing one or more dispersing or emulsifying agents such as, for example, surfactants, alkali-soluble polymer or mixtures thereof. In some instances, a reactive emulsifying agent may be incorporated into the latex as it is formed.

The term “multistage” when used with respect to a latex composition refers a polymer made using either discrete or continuous charges of two more monomers. A multistage latex does not typically exhibit a single Tg inflection point when analyzed by differential scanning calorimetry (DSC). For example, a DSC curve for a multistage latex made using discrete charges of two or more monomers may exhibit two or more Tg inflection points. Also, a DSC curve for a multistage latex made using a continuously-varied charge of two or more monomers may exhibit no Tg inflection points. By way of further explanation, a DSC curve for a single stage latex made using a single monomer charge or a non-varying charge of two monomers may exhibit only a single Tg inflection point. Occasionally when only one Tg inflection point is observed it may be difficult to determine whether the latex represents a multistage latex. In such cases a lower Tg inflection point may sometimes be detected on closer inspection, or the synthetic scheme used to make the latex may be examined to determine whether or not a multistage latex would be expected to be produced.

Unless otherwise indicated, a reference to a “(meth)acrylate” compound (where “meth” is bracketed) is meant to include both acrylate and methacrylate compounds.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

The term “volatile organic compound” (“VOC”) refers to any compound of carbon, excluding carbon monoxide, carbon dioxide, carbonic acid, metallic carbides or carbonates, and ammonium carbonate, which participates in atmospheric photochemical reactions. The term “low VOC,” as used herein, means a coating composition contains less than about 10% VOC, more preferably less than about 7% VOC, and most preferably less than about 4% VOC, based on the total weight of the coating composition.

Unless otherwise indicated, the term “polymer” includes both homopolymers and copolymers (i.e., polymers of two or more different monomers).

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

The present description provides methods that improve the adhesion of a coating to the surface of a substrate. The methods include steps of providing a non-metallic substrate, applying a pretreatment composition to the substrate, and applying a sealer over the pretreatment composition. Coated articles made by the described methods are also provided.

In an embodiment, the present description provides methods that include the step of applying a coating composition to a non-metallic substrate. In an aspect, the non-metallic substrate may be, for example, wood, vinyl, plastic, polyolefin, carbonaceous, cementitious, ceramic, and the like, with wood substrates preferred.

In an embodiment, the non-metallic substrate is a wood fiber composite board. A variety of wood composite boards may be used in the methods described here, including, for example, cement fiberboard. A wood fiber composite board typically includes a composite of fibers and a binder that includes water, silica, and hydraulic cement. The substrates can be made using methods known to those of skill in the art including, for example, extrusion. A variety of suitable fiber cement substrates are commercially available.

In a preferred aspect, the non-metallic substrate is a compressed fiber cement panel (CPC), or pressed fiber cement panel. Panels of this type are well known in the art and are commercially available. For example, several types of compressed fiber cement panels are available from James Hardie Co. (Mission Viejo, Calif.), such as the EXOTEC line of products. The compressed fiber cement panels may be used in a variety of applications. For example, the panels may be installed on the front facade of a building, and also in eaves, soffit and fascia. The compressed fiber panels are preferred for applications in commercial areas prone to wear and tear as the compressed fiber structure is known to be significantly impact resistant.

In an embodiment, the present description provides a method for improving adhesion of a coating to the surface of a substrate, preferably a non-metallic substrate, more preferably a wood fiber composite board. Conventionally, the uncoated surface of the wood fiber composite board has a highly basic or alkaline surface and is at least slightly textured or rough. Without limiting to theory, it is believed that such a textured or rough surface provides for some degree of mechanical interaction or interlocking with a coating applied to the surface and thereby promotes adhesion of the coating. However, some wood fiber composite boards, including for example, compressed fiber cement panels, have a smooth surface and coatings tend not to adhere to such smooth surfaces. In order to coat such substrates effectively, it is often necessary to introduce at least some surface texture or roughness.

Accordingly, the methods described herein provide a method to improve adhesion of a coating to a smooth surface of a wood fiber composite substrate. This may be accomplished by applying a pretreatment composition to the uncoated or bare surface of the substrate. In an aspect, the pretreatment is an acidic material. Without limiting to theory, the acidic material tends to produce texture or roughness to the substrate by etching the surface and also interacts with the substrate. The etched surface then provides a mode of mechanical interaction for any subsequently applied coating.

Suitable acidic pretreatment compositions include, for example, inorganic acids, organic acids, derivatives of inorganic acids, derivatives of organic acids, salts of inorganic acids, salts of organic acids, mixtures or combinations thereof, and other acidic pretreatment compositions as described, for example, in U.S. Pat. No. 8,202,581. Examples of organic acids or salts of organic acids include, without limitation, ethylenically unsaturated polymerizable carboxylic acids and corresponding metal salts, including, for example, titanium, manganese or zirconium salts, or any homopolymerizable and/or copolymerizable ethylenically unsaturated carboxylic acids known per se or salts thereof, namely: acrylic acid, methacrylic acid, itaconic acid, crotonic acid, maleic acid, maleic acid semiesters, i.e. esters of maleic acid in which a carboxyl group is esterified with an alkyl group, fumaric acid or fumaric acid semiesters, reactive carboxyfunctional macromonomers or mixtures of the acids mentioned above. The organic acid pretreatment composition may also include unsaturated C—C bonds, i.e. vinyl, acryl, methacryl or styryl groups, as terminal groups.

In another aspect, the organic acid pretreatment composition may also include silanes, such as, for example, si lane coupling agents, metals coupled with silanes, polymeric resins coupled with silanes, organofunctional silanes, mixtures and combinations thereof, and the like. For example, a pretreatment composition may include an azole-functional silane coupling agent, preferably an imidazole-functional silane coupling agent. Another example of a silane-based pretreatment includes silane coupling agents in combination with epoxy-functional resins.

Suitable inorganic acids include, without limitation, phosphorus acids, chromic acid, fluoro acids of metals, salts or derivatives thereof, and mixtures or combinations thereof. In an aspect, the acidic pretreatment is a coating composition that includes a hexafluoro salt of a metal, preferably hexafluorotitanic acid or hexafluorozirconic acid. A typical pretreatment composition would include the acidic component along with a polymeric binder resin and optional standard formulation additives. A variety of such pretreatments are commercially available, including, for example, the BONDERITE line of pretreatments (Henkel).

Mixtures of acids, salts or salts and acids may also be used in the methods described herein. Acids and salts having appreciable water solubility of at least about 5 wt %, at least 10 wt %, at least 20 wt %, at least 50 wt % or even complete miscibility are preferred, as are acids and acid salts with low toxicity and low or moderate tendency to irritate skin.

In an aspect, when used as a pretreatment composition, suitable acids, salts, and mixtures thereof, are applied to the surface of a wood fiber composite substrate as thin films with dry film thickness on the nanometer level. In an aspect, the dry film thickness of acidic pretreatment is about 1 to 100 nm, preferably 2 to 75 nm, more preferably 5 to 50 nm. Conventionally, the thickness of a thin film pretreatment is expressed as coating weight in milligrams per square foot. Accordingly, in an embodiment, the coating weight of the acidic pretreatment is about 1 to 20 mg/ft², preferably 5 to 15 mg/ft², more preferably 10-12 mg/ft².

In an embodiment, the methods described herein provide a method to improve adhesion of a coating to a smooth surface of a wood fiber composite substrate. This may be accomplished by applying a pretreatment composition to the uncoated or bare surface of the substrate. In an aspect, the pretreatment is a water-based polymeric material. Without limiting to theory, the polymeric material promotes adhesion by both etching the surface and providing chemical functionality on the substrate surface. The pretreated surface then provides a mode of chemical interaction for any subsequently applied coating.

Suitable polymeric pretreatment compositions include aqueous polymeric compositions such as, for example, acrylic latex materials, water-dispersible polyurethane materials, water-based epoxy materials, combinations or mixtures thereof, and the like. In a preferred aspect, the polymeric composition is an acrylic latex. Examples of acrylic latex material include, without limitation, (meth)acrylics, vinyls, oil-modified polymers, polyesters, polyurethanes, polyamides, chlorinated polyolefins, and mixtures or copolymers thereof. Latex polymers are readily synthesized at modest cost and provide a preferred class of aqueous dispersions of polymer particles. Latex polymers are typically prepared through chain-growth polymerization, using one or more olefinic compounds (preferably monomers) Non-limiting examples of olefinic compounds which may be used to prepare latex polymers include ethylene, butadiene, propene, butene, iso-butene, acrylic acid, methacrylic acid, methyl acrylate, ethyl acrylate, propyl acrylate, butyl acrylate, 2-ethylhexyl acrylate, methyl methacrylate, ethyl methacrylate, propyl methacrylate, butyl methacrylate, 2-ethylhexyl methacrylate, hydroxyethyl acrylate, hydroxyethyl methacrylate, hydroxypropyl acrylate, hydroxybutyl acrylate, hydroxybutyl methacrylate, glycidyl methacrylate, 4-hydroxybutyl acrylate glycidylether, acrylamide, methylacrylamide, styrene, α-methyl styrene, vinyl toluene, vinyl acetate, vinyl propionate, allyl methacrylate, acetoacetyl ethyl methacrylate (AAEM), diacetone acrylamide, dimethylaminomethacrylate, dimethylaminomethacrylate, N-hydroxy(meth)acrylamide, vinyl ether maleate, vinyl esters of VERSATIC™ acid (VERSATIC acid is a synthetic saturated monocarboxylic acid of highly branched structure containing about 5 to about 10 carbon atoms), and mixtures thereof. Preferably, the latex polymer is a (meth)acrylic polymer. Suitable latex compositions and methods for preparing the same are further described in U.S. Pat. No. 8,133,588, incorporated herein by reference.

In an embodiment, the pretreatment composition is a water-based epoxy material. Suitable examples include, without limitation, The epoxy coating system is typically a multi-component coating system that includes an epoxy coating system such as those described in International Patent Application No. WO 2008/018910 A1. Epoxy-based coatings include multi-functional epoxy-functional coatings, e.g., resins (e.g., di-, tri-, tetra-, and other multi-functional epoxy resins) that are prepared from aliphatic or aromatic starting materials. Aliphatic starting materials are presently preferred in cases where the starting material might be exposed for prolonged periods to UV radiation. Examples of such multi-functional epoxy resins include the reaction products of epoxy containing compounds (e.g., epichlorohydrin) with multi-functional alcohols or acids. Suitable epoxy compositions are commercially available, and include those described in U.S. Pat. No. 8,133,588, incorporated herein by reference.

In an embodiment, the methods described herein include a step of applying at least a sealer composition over the pretreatment composition already applied to the substrate. A variety of sealers may be employed in the present invention. Representative sealers typically will be aqueous compositions and include acrylic latex material, water-based epoxy compositions, water-dispersible polyurethane materials, combinations and mixtures thereof, and the like. In an aspect, the sealer may be the same polymeric composition applied initially as a pretreatment to the untreated or bare substrate. The sealer may, for example, provide one or more features such as improved adhesion, efflorescence blocking, water resistance or block resistance. Suitable sealers for use in the methods described herein include commercially available sealers and other sealer materials as provided in U.S. Pat. No. 8,202,581 and U.S. Pat. No. 8,133,588, incorporated herein by reference. The sealer may also preferably contain an adhesion-enhancing amount of a phosphorus acid or salt of a phosphorus acid, with salts of phosphorus acids being preferred and sodium or ammonium salts of phosphorus acids being especially preferred. For example, concentrations of about 0.1 to about 20, about 0.2 to about 15, about 0.3 to about 10 wt. % acid or salt may be employed, based on the total sealer weight. Addition of such an acid or salt to the sealer may provide a substantial improvement in topcoat adhesion.

Conventionally, sealers for wood fiber composite substrates are applied at film thickness at the micron level. For example, a typical polymeric composition applied as a sealer for wood fiber cement board would have dry film thickness on the order of 0.001 to about 0.3 mm (approximately 1 μm to 300 μm). In contrast, when a polymeric sealer is used as a pretreatment composition described herein, it is applied as a thin film, with dry film thickness at the nanometer level. In an aspect, the dry film thickness is about 1 to 100 nm, preferably 2 to 75 nm, more preferably 5 to 50 nm. Conventionally, the thickness of a thin film pretreatment is expressed as coating weight in milligrams per square foot. Accordingly, in an embodiment, the coating weight of the acidic pretreatment is about 1 to 20 mg/ft², preferably 5 to 15 mg/ft², more preferably 10-12 mg/ft².

In an embodiment, the present methods include a step of preheating the uncoated non-metallic substrate, preferably a wood fiber composite board or panel, prior to applying a pretreatment and/or sealer composition. In an aspect, this step includes heating the wood fiber composite board to a temperature of at least about 80° F., preferably about 90° F. to about 150° F., more preferably about 110° F. to about 130° F., and most preferably about 120° F. Without limiting to theory, it is believed that preheating the substrate forces out moisture or water from the substrate and thereby allows the pretreatment or presealer composition to penetrate the substrate and efficiently fill pores in the substrate. Alternatively, preheating may allow the substrate to swell or expand, allowing the pretreatment to permeate the substrate.

Optionally, after a sealer has been applied to the substrate, a primer and/or topcoat may also be applied. A variety of primers may be employed in the present invention. Representative primers include acrylic latex, or a styrene/acrylic latex, or vinyl primers. The primer may include color pigments, if desired. Preferred primers have a measured 60° gloss value less than 15 gloss units, more preferably less than 10 gloss units, and most preferably less than 5 gloss units, and a pigment volume concentration (PVC) of at least 5%. Preferred primers also provide blocking resistance. A recommended thickness for the primer after it is dried or otherwise hardened is about 2 to 50 micrometers and more preferably about 5 to about 30 micrometers.

A variety of final topcoat compositions may be employed in the present invention. Representative topcoats are well known in the art and preferably include a multistage latex polymer as described in U.S. Pat. No. 8,202,578, for example. The topcoat typically shrill include a carrier (e.g., water or one or more organic solvents), may include other ingredients such as color pigments if desired, and in some embodiments could be characterized as a paint. Preferred final topcoat compositions have a measured 60° gloss value greater than 1 gloss unit, and more preferably between 5 and 30 gloss units.

The disclosed coating systems or coating compositions preferably have improved, viz., lower, volatile organic content (VOC). The coating systems or coating compositions desirably have a VOC of less than about 5%, based on the total weight of the coating system, preferably a VOC of less than about 2%, more preferably a VOC of less than about 0.5%.

Other optional components for use in the coating systems herein are described in Koleske et al., Paint and Coatings Industry, April, 2003, pages 12-86. Typical performance enhancing additives that may be employed include surface active agents, pigments, colorants, dyes, surfactants, dispersants, defoamers, thickeners, initiators (e.g., photoinitiators), heat stabilizers, leveling agents, coalescents, biocides, mildewcides, anti-cratering agents, curing indicators, plasticizers, fillers, sedimentation inhibitors, ultraviolet light absorbers, optical brighteners, and the like to modify properties.

The coating systems may also contain an optional coalescent and many coalescents are known in the art. The optional coalescent is preferably a low VOC coalescent such as is described in U.S. Pat. No. 6,762,230.

The coating systems may be applied by any number of application techniques including but not limited to brushing (e.g., using a brush coater), direct roll coating, reverse roll coating, flood coating, vacuum coating, curtain coating and spraying. The various techniques each offer a unique set of advantages and disadvantages depending upon the substrate profile, morphology and tolerable application efficiencies. Lower viscosities facilitate uniform film control. The applied film thickness may be controlled for example by varying the application rate. The disclosed coating systems may for example be applied to a cement fiberboard substrate by roll coating. An overall dry film thickness (DFT) of the coating system on the cement fiberboard substrate may for example be in the range of, but not limited to, about 0.04 to about 12 mil (about 0.001 to about 0.3 mm), about 0.08 to about 8 mil (about 0.002 to about 0.2 mm), more preferably about 0.16 to about 4 mil (about 0.004 to about 0.1 mm). The pretreatment layer is applied at nanometer thickness, preferably about 5 to 50 nm, and does not contribute significantly to the DFT of the final coating system.

In an embodiment, the present description provides coated articles made by the methods described herein. The coated article may include two or more layers of coating compositions applied to a wood fiber composite board or panel. For example, the coated article may be a wood fiber composite board coated initially with a pretreatment composition followed by a topcoat, or a pretreatment layer followed by a sealer and a topcoat, or a sealer layer followed by a primer and a topcoat. In a preferred aspect, the coated article is a compressed fiber cement panel with a pretreatment layer applied to the surface, followed by a polymeric sealer layer, an optional primer layer, and finally, a topcoat. Preferably, the various coating layers are selected to provide a coating system that has good adhesion to the substrate and between the various layers of the system.

Coated articles as described herein may be used in a variety of ways, including as boards, panels or other components used on building exteriors, lap siding, vertical siding, soffit panels, trim boards, shingle replicas, stone replicas, stucco replicas, and the like. In particular, because the methods described herein improve adhesion of the coating to the substrate, coated articles may be able to withstand extreme climates without significant coating failure or change in appearance. In an aspect, a coated article according to the present description can withstand at least 10 freeze/thaw cycles, preferably at least 15 cycles, more preferably at least 25 cycles.

### EXAMPLES

The invention is illustrated by the following examples. It is to be understood that the particular examples, materials, amounts, and procedures are to be interpreted broadly in accordance with the scope and spirit of the inventions as set forth herein. Unless otherwise indicated, all parts and percentages are by weight and all molecular weights are weight average molecular weight. Unless otherwise specified, all chemicals used are commercially available from, for example, Sigma-Aldrich, St. Louis, Mo.

### Test Methods

Unless indicated otherwise, the following test methods were utilized in the Examples that follow.

### A. Dry Adhesion Test

The extent of adhesion of a coating system to a wood fiber composite board may be assessed by a dry adhesion test. In this test procedure, a six-inch length of 3M HD 250 tape is applied to the surface of one or more test panels. The tape is firmly pressed to the board by brushing for five passes and rolling for 10 passes to ensure full contact. The tape is then removed quickly by pulling it off by hand at a 90-degree angle to the board. The dry adhesion performance is reported as a percentage of the coating removed from the board. Performance may also be reported in terms of the type of failure observed, i.e. failure may occur at the interface between the sealer and the topcoat, or between the sealer and the substrate, or inside the board itself (fiber failure).

### B. Wet Adhesion Test

Wet adhesion testing is used to assess adhesion of the coating to a composite board after the board has been saturated with water. Test panels are soaked in water for a given period of time, typically at least 24 hours. The panels are then removed from water and allowed to dry for 5 minutes before performing tape pull. Adhesion is determined by the pull off tape test as provided in the dry adhesion test above and results are reported as a percentage of the coating removed and in terms of the type of failure.

### C. Freeze/Thaw Adhesion Test

The freeze/thaw adhesion test provides an assessment of the performance of a coating in extreme climates. Coated test panels are tested according to ASTM D6944-15 (Standard Practice for Determining Resistance of Cured Coatings to Thermal Cycling). The method may be modified to provide greater or fewer freeze/thaw cycles than indicated in the standard.

### Example 1

### Effect of Pretreatment

To determine the effect of pretreatment on adhesion of the topcoat to the substrate, samples of a compressed wood fiber cement panel are coated in triplicate, and tape pulls are performed three times per board. For each panel, pretreatment is applied at nanometer thickness, no sealer is used, and a white acrylic latex topcoat at a dry film thickness (DFT) of about 1.75 mil is applied over the pretreatment coating. Each panel is then tested for dry adhesion and wet adhesion. For the wet adhesion test, each panel is soaked in water for 48 hours and then allowed to dry for 5 minutes before testing. Average results for each type of sample are shown in Table 1 below.

TABLE 1
Effect of Pretreatment

| | | | Dry | Wet |
|---|---|---|---|---|
| | | | Adhesion | Adhesion |
| Test | | | (% coating | (% coating |
| Sample | Pretreatment | Topcoat | removed) | removed) |
| Control | — | White acrylic | 52.6 | 31.8 |
| #1 | Waterbased acrylic | White acrylic | 2.3 | 4.1 |
| #2 | Acidic pretreatment | White acrylic | 36.1 | 32.1 |
| | composition | | | |
| | (containing | | | |
| | hexafluorotitanic acid) | | | |
| #3 | Acidic pretreatment | White acrylic | 23.8 | 73.7 |
| | composition | | | |
| | (containing | | | |
| | hexafluorozirconic | | | |
| | acid) | | | |

### Example 2

### Effect of Preheating and Pretreatment

To determine the effect of a preheat step on adhesion of the topcoat to the substrate, samples of a cement fiber composite board (control and sample #1) and a compressed wood fiber cement panel (samples #2 to #9) were coated in triplicate and preheated before the application of any coating to the temperature shown in Table 2 below. Where pretreatment is used, it is applied at nanometer thickness. Where sealer is used, it is applied at a DFT of about 0.3 mil, except as otherwise noted. Each panel is also coated with a white acrylic topcoat. Each panel is then soaked in water for 48 hours and subjected to 25 freeze/thaw cycles and tested for adhesion. Average results for each sample are reported in Table 2 below, and a photographic comparison of panels corresponding to samples #3 (left) and #9 (right) is shown in FIG. 1.

TABLE 2
Effect of preheating and pretreatment

| | | | | F/T Adhesion |
|---|---|---|---|---|
| | Preheat Temp | | | (% coating |
| Sample | (° F.) | Pretreatment | Sealer | removed) |
| Control | — | — | | 8.6 |
| #1 | 120 | — | Waterbased | 5.0 |
| | | | epoxy (0.5 | |
| | | | DFT) | |
| #2 | 120 | Acidic | Acrylic latex | 24.0 |
| | | pretreatment | | |
| | | composition | | |
| | | (nm) | | |
| #3 | 120 | Acidic | Waterbased | 11.1 |
| | | pretreatment | epoxy | |
| | | composition | | |
| | | (nm) | | |
| #4 | 120 | Acrylic latex | Waterbased | 21.6 |
| | | | epoxy | |
| #5 | 120 | Waterbased | Acrylic latex | 39.2 |
| | | epoxy | | |
| #6 | 130 | | Waterbased | 42.8 |
| | | | epoxy | |
| #7 | 110 | — | Waterbased | 45.2 |
| | | | epoxy | |
| #8 | 95 | — | Waterbased | 66.1 |
| | | | epoxy | |
| #9 | 80 | — | Waterbased | 71.8 |
| | | | epoxy | |

### Example 3

### Effect of Coating Thickness

To determine the effect of dry film thickness (DFT) on adhesion, test panels of a wood fiber composite board are coated with an acrylic latex sealer composition at various DFT values. The panels are then coated with a white acrylic topcoat at a DFT of about 1.75 mil. Where a pretreatment composition is used, it is applied at nanometer thickness. The panels are tested for dry adhesion, wet adhesion and freeze/thaw adhesion. For wet adhesion testing, the test panels were soaked for 48 hours in water and after the panels have been dried for about 5 minutes. For freeze/thaw testing, the panels were soaked in water for 48 hours, subjected to 25 freeze/thaw cycles, followed by drying for five minutes. Results are shown in Table 3.

TABLE 3
Effect of Film Thickness

| | | | Dry | Wet | F/T |
|---|---|---|---|---|---|
| Sample | Pretreatment | Sealer DFT | Adhesion | Adhesion | Adhesion |
| Control | — | — | 52.6 | 31.8 | — |
| 1 | — | 0.1 | 6.3 | 4.0 | 88.9 |
| 2 | — | 0.3 | 0.3 | 0.4 | 87.1 |
| 3 | — | 0.5 | 0.4 | 1.4 | 67.0 |
| 4 | — | 0.7 | 0.3 | 2.2 | 61.8 |
| 5 | Acidic | 0.3 | — | — | 39.6 |
| | pretreatment | | | | |

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

1. A method of making a coated article, comprising:
providing a non-metallic substrate;
optionally, preheating the substrate to a temperature of about 85° F. to 130° F.;
applying to the preheated substrate a pretreatment composition; and
applying on top of the pretreatment at least a sealer composition,
wherein the pretreatment provides enhanced adhesion of the sealer to the substrate.

2. The method of any of the above claims, wherein the non-metallic substrate is a material selected from wood, vinyl, plastic, polyolefin, carbonaceous, cementitious, ceramic and combinations thereof.

3. The method of any of the above claims, wherein the non-metallic substrate is a wood material.

4. The method of any of the above claims, wherein then non-metallic substrate is a wood fiber cement composite board.

5. The method of any of the above claims, wherein the non-metallic substrate is a compressed fiber panel board with a smooth surface.

6. The method of any of the above claim, wherein the pretreatment composition comprises an acidic inorganic material.

7. The method of any of the above claims, wherein the pretreatment composition comprises at least one hexafluoro acid or a salt of a hexafluoro acid.

8. The method of any of the above claims, wherein the pretreatment composition comprises a coating composition that includes hexafluorotitanic acid.

9. The method of any of the above claims, wherein the pretreatment composition is a coating composition that includes hexafluorozirconic acid.

10. The method of any of the above claims, wherein the pretreatment is an acidic organic material.

11. The method of any of the above claims, wherein the pretreatment is an aqueous polymeric composition.

12. The method of any of the above claims, wherein the pretreatment is an acrylic latex polymer.

13. The method of any of the above claims, wherein the pretreatment composition is applied as a thin film of nanometer thickness.

14. The method of any of the above claims, wherein the substrate is preheated to a temperature of about 120° F.

15. The method of any of the above claims, wherein the sealer composition is a waterbased polymeric material.

16. The method of any of the above claims, wherein the sealer is a multistage acrylic latex.

17. The method of any of the above claims, wherein the sealer is a waterbased polyurethane dispersion.

18. The method of any of the above claims, wherein the sealer is a waterbased epoxy composition.

19. The method of any of the above claims, wherein the pretreatment composition and sealer composition are identical.

20. The method of any of the above claims, wherein the pretreatment composition comprises the sealer composition applied as a thin film at a coating weight of 10 to 12 mg/ft².

21. The method of any of the above claims, wherein the sealer composition is applied at a dry film thickness of about 0.1 to 0.7 mil.

22. The method of any of the above claims, wherein the sealer composition is applied at a dry film thickness of about 0.25 to 0.5 mil.

23. The method of any of the above claims, further comprising applying a waterbased topcoat composition over the sealer composition.

24. The method of any of the above claims, further comprising applying a waterbased acrylic topcoat composition over the sealer composition.

25. A coated article made by the method of any of the above claims.
